(19) United States
(12) Patent Application Publication
(10) Pub. No.: US 2017/0102073 A1
(43) Pub. Date: Apr. 13, 2017

(54) FLEXIBLE PLATE APPARATUS FOR COMPRESSING SEALS AND PACKING

(71) Applicant: Valve Enhancement Technologies, LLC, Portland, ME (US)

(72) Inventor: Matthew Jan WASIELEWSKI, Portland, ME (US)

(21) Appl. No.: 15/272,843

(22) Filed: Sep. 22, 2016

Related U.S. Application Data
(60) Provisional application No. 62/240,627, filed on Oct. 13, 2015.

(51) Int. Cl. F16J 15/18; F16K 41/02

(52) U.S. Cl. CPC F16J 15/184; F16K 41/02

(57) ABSTRACT

A flexible plate apparatus and related kit for compressing seals and packing. The apparatus increases sealing performance of valve stems or rotating shafts in industrial machines or equipment. The apparatus is formed by multiple plates which provide flex under loading conditions without material fatigue.

### CROSS-REFERENCE TO RELATED APPLICATIONS

The present invention claims priority from U.S. Provisional Application No. 62/240,627 filed 13 Oct. 2015, the contents of which are herein incorporated by reference in its entirety.

### FIELD OF THE INVENTION

The present invention relates to seals for use in leakage protection from valve stems or rotating shafts in industrial machines.

### BACKGROUND OF THE INVENTION

Within industrial settings, a variety of mechanisms exist to prevent leakage from the stuffing box area of valve stems, rotating shafts, or other pressure containing structures. Indeed, the need to provide an even better stem or shaft seal has arisen as a result of increasingly stringent requirements regarding “fugitive emissions” by the US EPA and other global organizations. Fugitive emissions are leaks to the atmosphere that occur from valves, pipe joints, pumps, and other processing equipment through which fluids (gases and liquids) are transferred or stored. These emissions are most prevalent from dynamic shaft/stem seals since the compressive loading of the seals is lessened due to frictional wear, extrusion and contraction of seals due to thermal effects.

Corrosion of the inner lining of a stuffing box can occur especially when a weakened gland flange or washer incurs a reduced compression strength. In such situation, when the stem is raised or lowered in valve operation, the weakened seal will cause some of the fluid product to migrate along the stuffing box and come in contact with the packing material therein. Over time, the corrosive nature of the material will cause pitting in the stuffing box as well as attack the packing material itself leading to part failure. Strict regulations regarding fugitive emissions provide ample incentive to reduce such part failure.

Stem/shaft seals or packing generally consist of multiple rings of packing and a follower. The packing can be braided or die-formed graphite, elastomers, polymers, synthetic or naturally occurring materials. The follower is used to compress the packing, which expands the material inward and outward to create a seal between the shaft and housing. The follower itself is typically forced (or loaded) against the packing by bolts or a nut with or without additional compressive elements such as a compression plate or washers. One example of such a seal is shown and described by U.S. Pat. No. 5,454,547 granted to Brown.

Spring washers, also known as Belleville washers, have been used for many years. Such washers are also known as coned-disc springs, conical spring washers, disc springs, or cupped spring washers. They are basically a type of spring shaped like a washer with a frusto-conical shape that gives the washer a spring characteristic. These washers are limited in size and have a limited range of usable force. Belleville washers are typically used as springs, or to apply a pre-load of flexible quality to a bolted joint or bearing as shown in prior art FIGS. 1 and 2. Valve or pump shaft or stem seal designs utilizing Belleville washers are often referred to as being “live-loaded.” Valve designs often need to be modified to account for the longer gland studs required for the Belleville washers. Because of the size limitations of the washers, they provide limited loading capability to the shaft seals. FIG. 1 shows a first configuration 100 with washers 10, 11 in place around shafts, while configuration 200 in FIG. 2 shows washer 20 in place around bolts.

Most valves simply compress the stem packing by the use of a compression plate or gland flange such as shown by prior art FIGS. 3 and 4. Here, the plate 35 is loaded on a shaft 32 by nuts 30, 34 and studs 31, 33. Typically, two or more bolts/studs are provided. The gland flanges are generally cast or forged steel and are thick, so as to not deform while loaded to the proper level. As such, the gland flanges do not provide any stored potential energy like spring washers. They may not provide active compression over time given various operating conditions and temperatures.

It would be advantageous to obviate or mitigate the disadvantages of known stem/shaft sealing arrangements.

### SUMMARY OF THE INVENTION

The present invention provides a cost effective solution to reducing fugitive emissions in new, as well as reworked and refitted, valves and shaft apparatus. The present invention therefore has the environmental benefit of allowing used valves to be refurbished to allow reduced fugitive emissions for extended durations. It also, by enabling the continued use by industry of refitted and refurbished valves, provides an additional environmental benefit because these reworked or refitted valves would otherwise find their way into landfills.

The present invention replaces the compression plate or gland flange with a plurality of thinner plates that are stacked together. The thickness, shape and number of plates are engineered to supply the compressive stress required for the seals/packing. The plates are assembled in a similar manner as a standard gland flange, and the gland nuts torqued to the required amount. The cumulative plates are allowed to flex, which creates stored potential energy like a spring washer though more similar to a leaf spring. Because the plates are thinner, the stresses in them do not exceed their yield strength so they return to their original shape. In terms of retrofitting existing valves and shaft apparatus, the general collective shape of the inventive plates can be similar to that of a singular preexisting compression plate, so no major design change is needed to the given valve/pump within which the present invention is provided.

According to a first aspect of the invention there is provided a flexible plate apparatus for compressing seals and packing, the apparatus including: a plurality of plates, each the plate including a central aperture and at least two lateral apertures, wherein the central aperture is configured to accept a shaft and the lateral apertures are configured to accept a stud upon which corresponding nuts are installed, and tightening of the nuts compresses the plurality of plates against valve packing.

According to a second aspect of the invention there is provided a valve stem sealing device, the device including: a stem movable from a first position to a second position; packing surrounding the stem for maintaining a seal between a first environment and a second environment; a plurality of plates formed from sheet metal, each the plate including a central aperture through which the stem is movable and providing a live-loading force upon the packing sufficient to preclude leakage between the first environment and the second environment through a range of movement of the stem from the first position to the second position.

According to a third aspect of the invention there is provided a kit for retrofitting a stem seal, the kit including: a plurality of plates capable of providing a yield strength precluding permanent bending under load, each the plate including a central aperture and at least two lateral apertures, the central aperture capable of accepting a stem shaft and the lateral apertures capable of accepting a stud upon which corresponding nuts are installable, whereby tightening of the nuts compresses the plurality of plates against valve packing surrounding the stem shaft.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a first known type of spring washer arrangement.

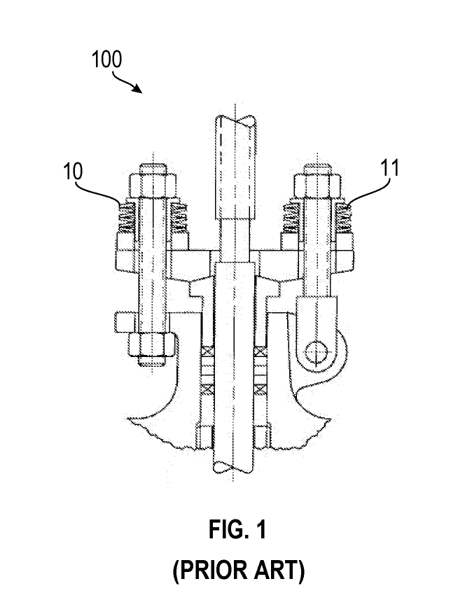

FIG. 2 is a second known type of spring washer arrangement.

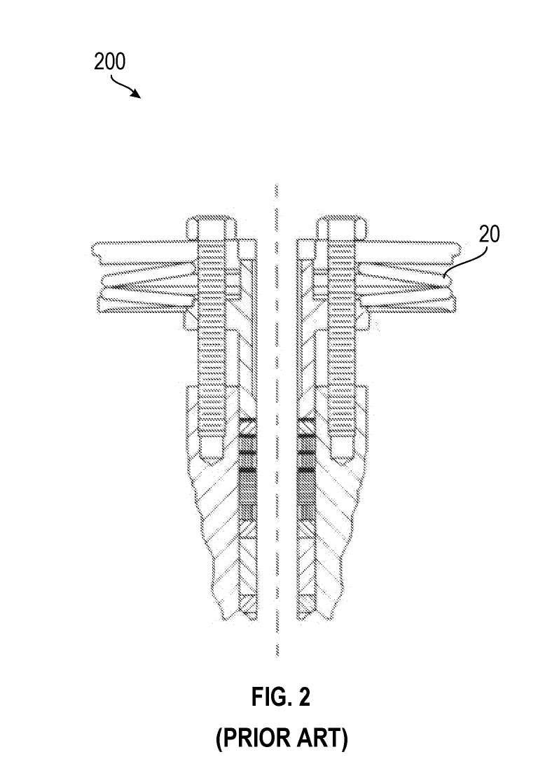

FIG. 3 is a known type of gland flange arrangement.

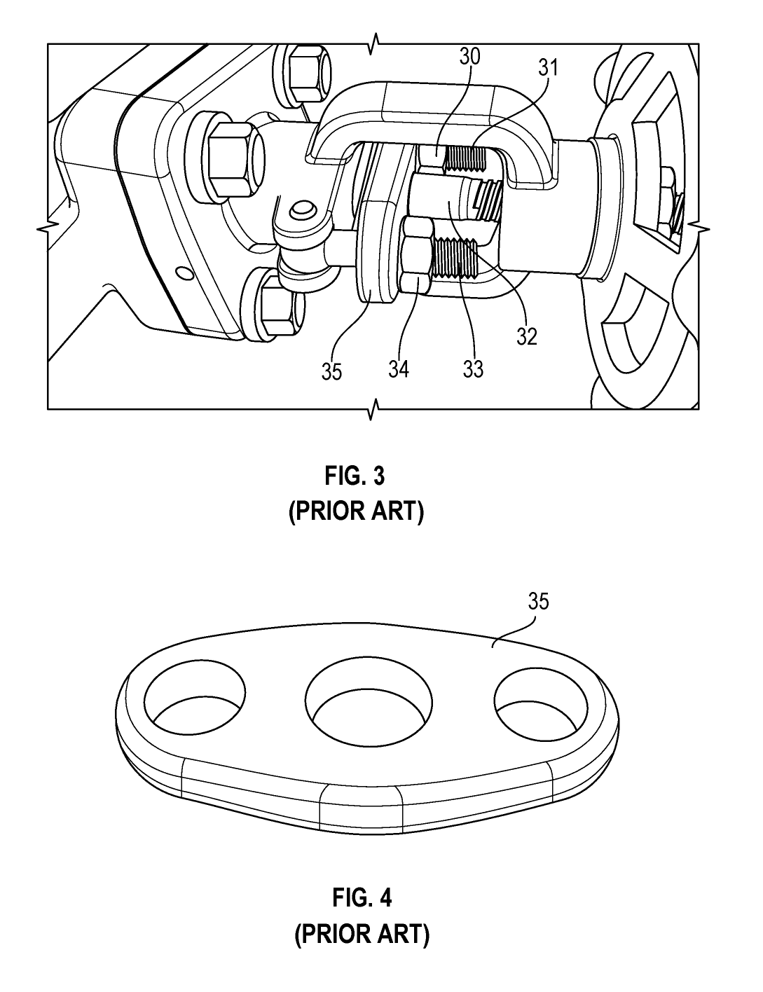

FIG. 4 is a perspective view of the gland flange of FIG. 3.

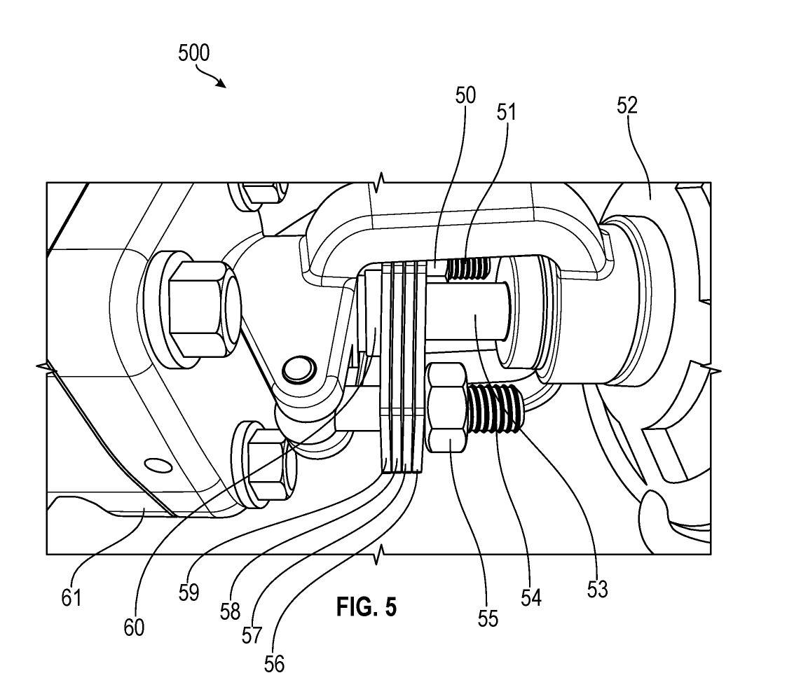

FIG. 5 is a perspective view showing a multi-plate arrangement according to one embodiment of the present invention;

FIG. 6 is a top view of the multi-plate arrangement of FIG. 5 in a state prior to force loading.

FIG. 7 is a top view of the multi-plate arrangement of FIG. 6 in a force loaded state.

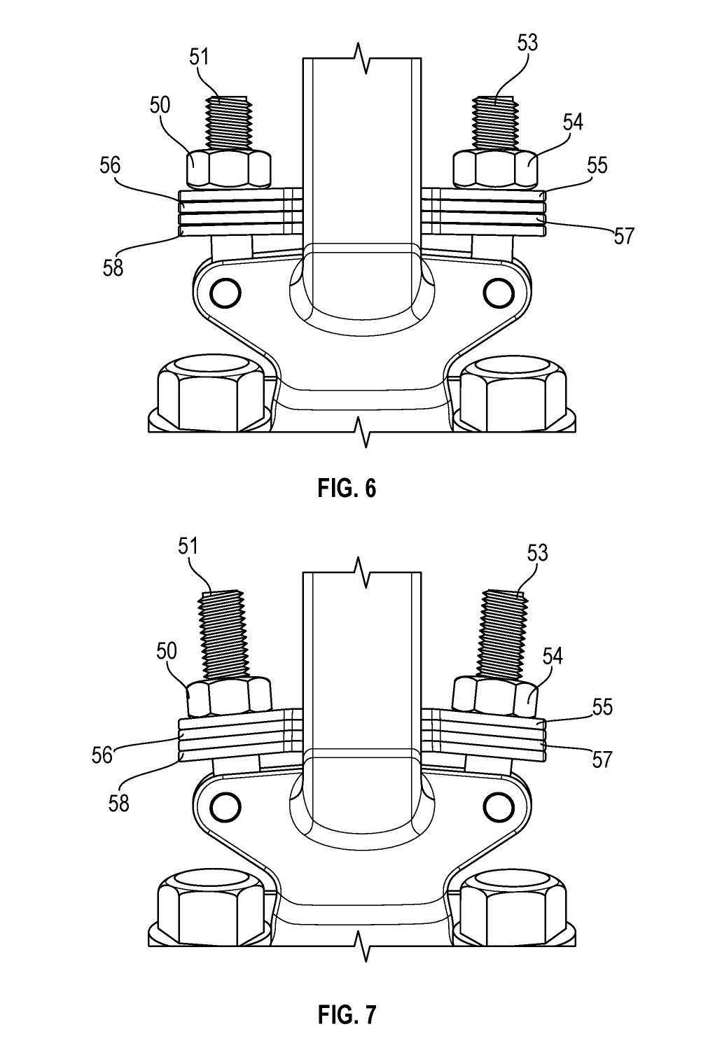

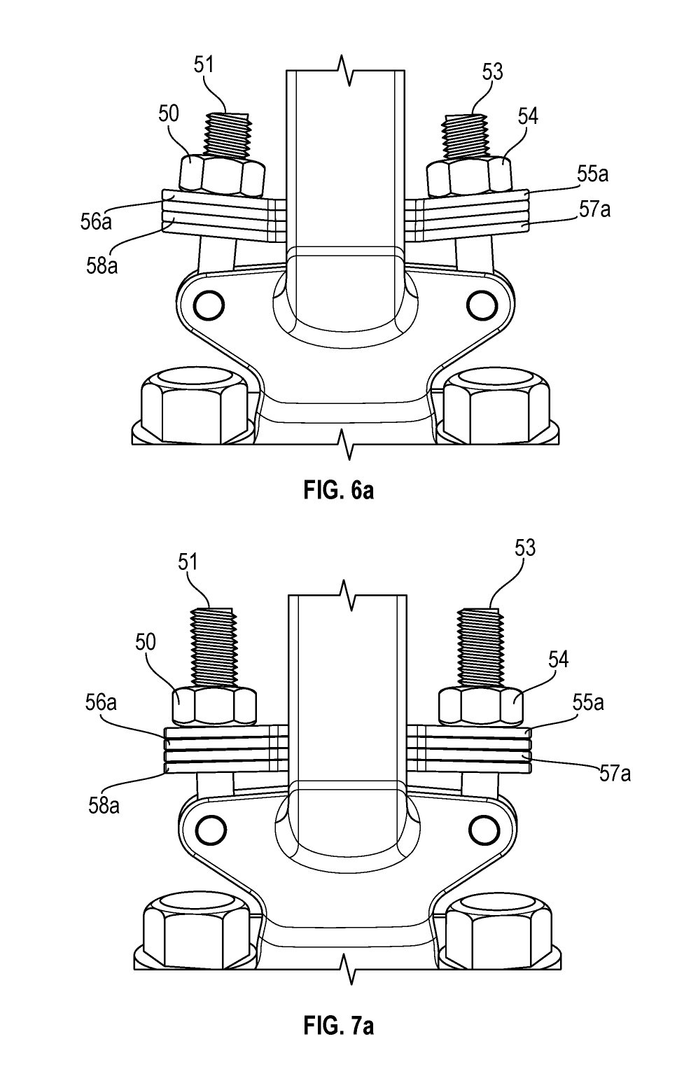

FIG. 6a is a top view of an alternative multi-plate arrangement similar to FIG. 5 though including a pre-bent plate in a state prior to force loading.

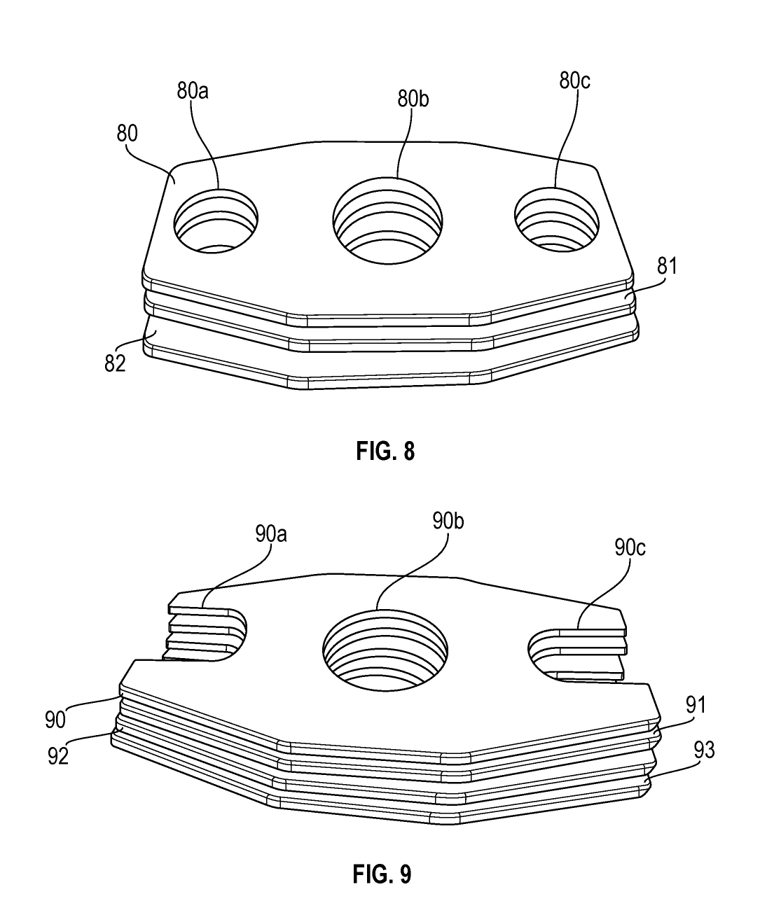

FIG. 7a is a top view of the alternative multi-plate arrangement of FIG. 6a in a force loaded state.

FIG. 8 is a perspective view of three plates of the type of multi-plate arrangement of FIG. 5.

FIG. 9 is a perspective view of an alternative version of plates of the multi-plate arrangement in accordance with the present invention.

### DETAILED DESCRIPTION

Reference will first be made to FIGS. 5 through 8, which illustrate a flexible plate apparatus for compressing seals and packing according to one embodiment of the present invention.

FIG. 5 represents a valve configuration using the flexible plate apparatus of the present invention. The basic structure of the valve configuration of course includes a valve handle 52 and valve mechanism 61. Details of the valve mechanism 61 and inner seal packing are well known in the art and not further described or shown. In terms of the inventive aspect of the instant invention, the flexible plate apparatus of the present invention includes a plurality of thin compression plates (four shown) 56, 57, 58, 59. Because the compression plates in accordance with the present invention are fabricated of thin metal, the compression plates allow for bending but not yielding. In other words, the compression plates avoid any permanent bending and thereby provide a unique way to live-load a stem seal. Collectively, the plates 56, 57, 58, 59 are held upon shaft 53 and secured in place on studs 51, 54 by nuts 50, 55. Tightening of the nuts 50, 55 effectively loads the plates 56, 57, 58, 59 against the follower 60 thereby maintaining a positive seal within the valve mechanism 61. FIG. 6 and FIG. 7, respectively show the flexible plate apparatus of the present invention before and after loading.

FIG. 6a and FIG. 7a, respectively show an alternative embodiment of the flexible plate apparatus in accordance with the present invention before and after loading. In this embodiment, the plates 56a, 57a, 58a, 59a are initially provided in a pre-bent configuration. Specifically, plates 56a, 57a, 58a, 59a, are manufactured in the angled (i.e., pre-bent) shape as shown. This requires a force to “straighten” the plates as seen in FIG. 7a. In this manner, the embodiment shown in FIGS. 6a and 7a are functionally equivalent to the arrangement shown in FIGS. 6 and 7. However, upon tightening of bolts 50, 54 in FIG. 6a, the result is a fully loaded set of plates that are arranged in parallel without any angular bending—that is to say, the pre-bent plates 56a, 57a, 58a, 59a after being force loaded will appear flat and planar. Such alternative embodiment is useful for applications where a user may prefer a flatter aesthetic. As well, it should be noted that the bottom face of each bolt 50, 54 will be more perfectly flush and abutting with the top-most plate 55a in this alternative embodiment.

Although a valve configuration is shown, it should be readily apparent that the invention enhances the ability of a valve, pump or any piece of equipment with a stem/shaft seal or packing to prevent leakage of the working fluid media (gas or liquid) out into the atmosphere. Likewise, the present invention also enhances the sealing of any piece of equipment which is trying to hold a vacuum to not have outside pressure leak into the equipment's inner workings.

As mentioned, when a typical seal/packing wears from moving or deforms due to temperature changes, some of its thickness is reduced, causing the compressive load or stress of the seal/packing to be reduced. The lower packing stress or load results in leakage through the seal. Also, when a typical seal's temperature increases, the seal expands and extrudes unless there is a mechanism to allow for the expansion. If there is not, and temperature is then decreased, the seal contracts and its compressive load is lost and the seal leaks. In contrast, the inventive flexible plate apparatus does not suffer from these disadvantages related to temperature variations. Indeed, the live-loading placed upon a stem seal by the inventive compression plates provides increased sealing ability even as the stem seal wears and expands/contracts due to temperature changes.

Furthermore, live-loading of the present invention allows for more control over packing stresses as well as a reduction in over-compression of seals/packing which increases seal like and performance. Therefore, the compression plates in accordance with the present invention are able to supply a minimum amount of required force to a packing gland over a wide range of packing displacement from wear and temperature changes. The invention is useful for most all valves used in the petro/chemical markets that are concerned with leakage to the atmosphere due to the invention's improved sealing ability which ensures compliance to fugitive emission standards.

The present invention also provides a larger range of useable loading to the stem seal/packing than a Belleville washer or a non-live-loaded design. The invention does not require any change to the basic product configuration (e.g., valve itself). The invention is fabricated from sheet metal parts that may be efficiently manufactured with related reduction in costs. The invention is easily customized for different seal designs used in the same product by altering just the number of plates. Such customization enables a variable seal load by changing the number of plates where increasing the number of compression plates would provide a related increase in loading force. Thus, seal loads may be easily altered by changing the number of compression plates provided.

For example, FIG. 8 is a perspective view of three plates 80, 81, 82 of the type of multi-plate arrangement of FIG. 5. As shown by viewing the top most plate 80, each plate includes a central aperture 80b for passage of the given shaft/stem along with lateral apertures 80a, 80c. Each plate includes such apertures which are of course aligned. If more than one stud/bolt exist in any given valve configuration, it should be understood that more than the two lateral apertures shown may be needed. It should therefore be readily apparent that the present invention may be used in conjunction with devices other than the exemplary valve as shown. Specifically, the present invention may be used on many different configurations of valves, pumps, other petro/chemical processing equipment, marine shaft seals, engine seals or any other compression packing setup that has at least two gland studs/nuts.

As valve configurations may of course vary, it should be understood that the specific shape of the flexible plate apparatus of the present invention may also vary accordingly though without straying from the intended scope of the invention. For example, FIG. 9 is a perspective view of an alternative version of plates of the multi-plate arrangement in accordance with the present invention. Here, four plates 90, 91, 92, 93 are illustrated. As shown by viewing the top most plate 90, each plate includes a central aperture 90b for passage of the given shaft/stem along with lateral apertures 90a, 90c which in this embodiment are shown as U-shaped notches rather than a circular aperture.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A flexible plate apparatus for compressing seals and packing, said apparatus comprising:
a plurality of plates, each said plate including a central aperture and at least two lateral apertures,
wherein said central aperture is configured to accept a shaft and said lateral apertures are configured to accept a stud upon which corresponding nuts are installed, and tightening of said nuts compresses said plurality of plates against valve packing.

2. The apparatus as claimed in claim 1 wherein each said plate is formed from sheet metal.

3. The apparatus as claimed in claim 2 wherein each said plate is configured to provide a yield strength precluding permanent bending under load.

4. The apparatus as claimed in claim 1 wherein said plurality of plates is configured to supply a force sufficient to compress seals and packing over a range of temperatures.

5. The apparatus as claimed in claim 1 wherein said plurality of plates is configured to supply a force sufficient to compress seals and packing as said seals and packing wears.

6. The apparatus as claimed in claim 1 wherein each one of said plurality of plates is pre-bent in a direction opposite to a force applied by said tightening of said nuts.

7. A valve stem sealing device, said device comprising:
a stem movable from a first position to a second position;
packing surrounding said stem for maintaining a seal between a first environment and a second environment;
a plurality of plates formed from sheet metal, each said plate including a central aperture through which said stem is movable and providing a live-loading force upon said packing sufficient to preclude leakage between said first environment and said second environment through a range of movement of said stem from said first position to said second position.

8. The device as claimed in claim 7 wherein said plurality of plates is configured to supply said live-loading force over a range of temperatures.

9. The device as claimed in claim 7 wherein said plurality of plates is configured to supply said live-loading force as said packing wears.

10. The device as claimed in claim 7 wherein each said plate includes at least two lateral apertures, said central aperture is configured to accept a shaft, and said lateral apertures are configured to accept a stud upon which corresponding nuts are installed, and tightening of said nuts compresses said plurality of plates against said packing.

11. The device as claimed in claim 10 wherein each said plate is configured to provide a yield strength precluding permanent bending under load.

12. The device as claimed in claim 7 wherein each one of said plurality of plates is pre-bent to provide said live-loading force.

13. A kit for retrofitting a stem seal, said kit comprising:
a plurality of plates capable of providing a yield strength precluding permanent bending under load, each said plate including a central aperture and at least two lateral apertures,
said central aperture capable of accepting a stem shaft and said lateral apertures capable of accepting a stud upon which corresponding nuts are installable, whereby tightening of said nuts compresses said plurality of plates against valve packing surrounding said stem shaft.

14. The kit as claimed in claim 13 wherein each said plate is formed from sheet metal.

15. The kit as claimed in claim 13 wherein said plurality of plates is capable of supplying a force sufficient to compress said packing over a range of temperatures.

16. The kit as claimed in claim 13 wherein said plurality of plates is capable of supplying a force sufficient to compress said packing as said packing wears.

17. The kit as claimed in claim 13 wherein upon stem movement from a first position to a second position, said plurality of plates is capable of providing a live-load to said packing surrounding said stem so as to maintain a seal between a first environment and a second environment, said live-load being sufficient to preclude leakage between said first environment and said second environment through a range of movement of said stem from said first position to said second position.

18. The kit as claimed in claim 13 wherein each one of said plurality of plates is pre-bent in a direction opposite to a force applied by said tightening of said nuts.
